(19) United States
(12) Patent Application Publication
(10) Pub. No.: US 2019/0283509 A1
(43) Pub. Date: Sep. 19, 2019

(54) Circumferential Automobile Tire Bands and Methods Associated Therewith

(71) Applicant: Deepakkumar Motibhai Patel, Kernersville, NC (US)

(72) Inventor: Deepakkumar Motibhai Patel, Kernersville, NC (US)

(21) Appl. No.: 15/920,781

(22) Filed: Mar. 14, 2018

(51) Int. Cl. B60C 19/00

(52) U.S. Cl. CPC B60C 19/00

(57) ABSTRACT

Products and kits for automobile tires and methods to increase the visibility and the aesthetic qualities of automobile tires is disclosed. An elastic band that has elastic properties that can be affixed to the circumference of automobile tires that increases the visibility and aesthetic qualities of tires is also disclosed, The elastic band may be colored in nature allowing others to view the elastic bands in the grooves of automobile tires. The elastic bands may be brightly or neon colored and may contain reflective paint that further increases their visibility and also their aesthetic quality. Kits are also disclosed that contain the elastic bands of the present invention.

### BACKGROUND OF THE INVENTION

Around 1839, Charles Goodyear developed vulcanized rubber, which was later used in automobile tires. The gasoline powered automobile is generally acknowledged to have been invented by Karl Benz in the mid to late 1880s. In Benz's early automobiles, he used metal tires that were covered by rubber and filled with air, resulting in a pneumatic tire. The pneumatic tire was a tremendous improvement over the hard metal tires (or wood tires) that had been commonly in use as it provided a much less bumpy and rigid ride. By 1895, pneumatic tires were commonly in use, and they were used in one of the early automobile races from Paris to Bordeaux.

Improvements continued to be made to the pneumatic tire after 1895. In or around 1905, tread patterns were added to tires. The tread patterns had the purpose of decreasing hydroplaning when the tires were used on a wet surface (for example, during a rain storm), allowing the water to be expelled from below the surface of the tire. The addition of treads also protected the carcass (the inner layer of cord fabric of a tire) and the breaker (a cord layer that occurs between the carcass and tread to protect the carcass). Around 1920, Henry Ford developed conveyor belt assembly lines allowing the mass production of the automobile. Around this time, Du Pont was successful in industrializing synthetic rubber, allowing not only the increase in quantity but also the increase in the quality of the tire. The Du Pont methodology meant that rubber was made from the polymers found in crude oil.

Around 1940, because of World War II, and the increase in the cost of oil, the automobile manufactures made smaller cars, smaller tires, and tubeless tires to increase fuel efficiency. In the 1950s, the radial tires were developed meaning the cords and the carcass were oriented in a direction that was parallel to the direction of travel, resulting in more uniform road contact of the tread with the road. This change also resulted in increased fuel efficiency and good stability, particularly when automobiles were driven at high speed. In the 1970, run flat tires were developed, meaning that a punctured tire could still be driven. Since the 1970s, tire manufacturers have continued to increase the performance of tires such as developing ultra high performance tires and environmentally friendly tires. As tires were developed it was also found that the addition of grooves in tires could increase safety by further reducing hydroplaning (more than the tread along). Over time, it was found that the proportion of rubber to air space (such as is present in grooves) was instrumental in determining the exemplar traction that could be attained by tires. Most automobile tires have a plurality of grooves, for example, four grooves in them that span the circumference of the tire. As the treads wear out with tire use, the grooves have less depth to them.

Not long after the development of synthetic rubbers, carbon black was added to tires increasing the durability of tires by a reduction in the heat from the tread and belt area of the tire. This also made automobile tires, which for years had been white, black. Many believe that the use of black tires on automobiles made the tires, and consequently, the automobile, less visible. Thus, the present invention is designed to make tires not only more visible put to also make them more aesthetically pleasing to the eye. It is believed that features that are added to automobiles that make them more visible also, on the whole, make them safer (e.g., less liable to be involved in crashes).

### BRIEF SUMMARY OF THE INVENTION

The present invention relates to products and kits for tires and methods to increase the visibility and the aesthetic qualities of tires. In an embodiment, the present invention relates to a product that can be added to the circumference of tires to increase the visibility and aesthetic qualities of tires. In a variation, the present invention relates to a band that has elastic properties that can be affixed to the circumference of tires that increases the visibility and aesthetic qualities of tires. In a variation, the present invention relates to an elastic band and methods of using said bands that allows the bands to be placed in grooves of tires not only increasing their visibility but also their aesthetic quality.

### BRIEF DESCRIPTION OF THE SEVERAL VIEWS OF THE DRAWING

FIG. 1 shows a side view of an automobile tire that contains a tread pattern and grooves.

FIG. 2 shows a side view of an automobile tire that contains a tread pattern, grooves and a band present in the groove.

FIG. 3 shows a cross-sectional view of the circumference of a tire showing the tread, a groove, and a band present in the groove.

FIG. 4 shows a perspective view of a band of the present invention without an automobile tire.

### DETAILED DESCRIPTION OF THE INVENTION

The present invention relates to products and kits for tires and methods to increase the visibility and the aesthetic qualities of tires. In an embodiment, the present invention relates to a product that can be added to the circumference of tires to increase the visibility and aesthetic qualities of tires. By making the tires more visible, this should also increase the safety of the automobile by making it less likely that other drivers will hit the automobile containing the product. In a variation, the present invention relates to a band that has elastic properties that can be affixed to the circumference of tires that increases the visibility and aesthetic qualities of tires. In a variation, the present invention relates to an elastic band and methods of using said bands that allows the bands to be placed in grooves of tires not only increasing their visibility but also their aesthetic quality.

In an embodiment, the present invention relates to an elastic band that has a circumference that is smaller than the circumference of the treads of an automobile tire. In a variation, the elasticity of the elastic band is slightly smaller than the circumference of groove on an automobile tire. The elastic band has an elasticity that allows the band to become greater than the circumference of the automobile tire allowing the elastic band to be placed in a groove of the automobile tire.

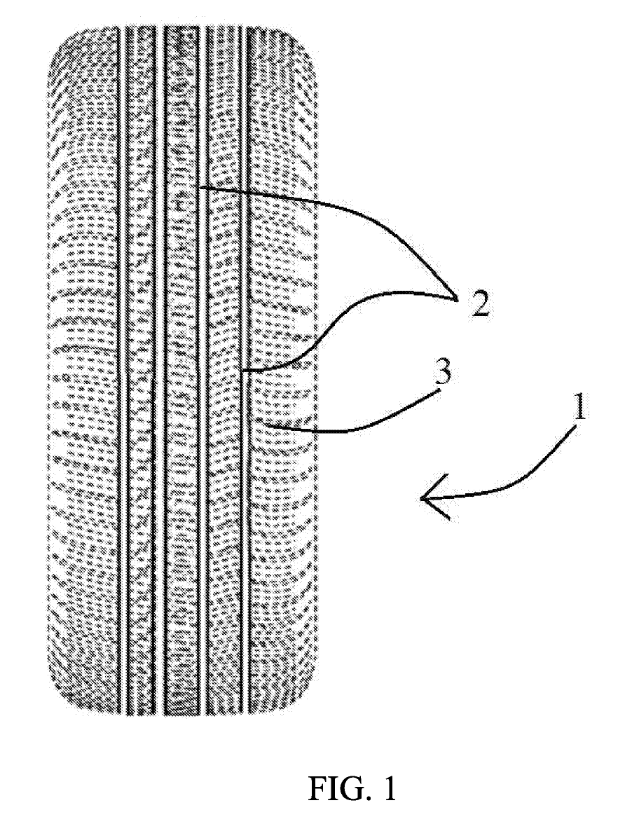

The invention will be discussed with reference to the figures. It should be understood that this is in no way meant to limit the invention but is merely meant to be illustrative of the invention. As can be seen in FIG. 1, an automobile tire 1 is shown that has a tread pattern 3 and grooves 2 in the automobile tire. The automobile tire is shown with four grooves, which is typical of most tires.

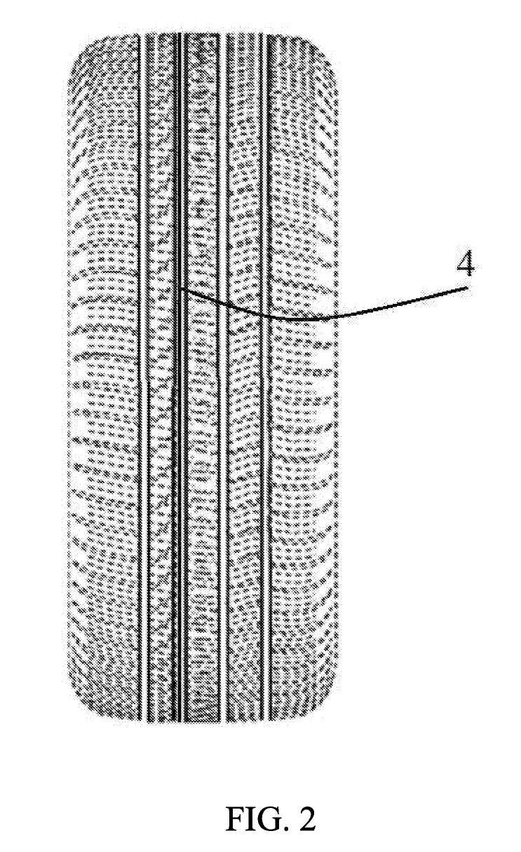

As is shown in FIG. 2, the automobile tire is shown with elastic band 4 in one of the grooves 2. As was explained above, the elastic band should have a circumference, which, in one embodiment, is slightly smaller than the circumference of the tread on the tire so that it will remain in the groove of the tire. The elasticity of the band should be sufficient so that the band is able to expand to a circumference that is larger than the circumference of the tire but when it returns to its non-expanded state it is able to stay in the groove of the automobile tire. In an embodiment, the band has a circumference that is smaller than the circumference of the tire groove. In this embodiment, the band should still be able to expand to a size that is larger than the circumference of the tire so that it can fit on the tire. Because the circumference of the band is slightly smaller than the circumference of the tire at the groove, the band when placed in the groove does not return to its complete non-expanded state. Rather, the band 4 that is in the groove 2 remains slightly expanded and thus it sit snugly against the circumference of the tire in the tire groove.

In an embodiment, the band is made with natural rubber rather than synthetic rubber as natural rubber has enhanced expansion properties relative to its synthetic counterparts. In another embodiment, the band is comprised of a mix of natural and synthetic rubbers that gives the band intermediate expansion properties. In a variation, the band is made of synthetic rubber meaning that the band has reduced expansion properties relative to a band that contains a mix of natural and synthetic rubber. It should be apparent to one of ordinary skill in the art that the material that is used for the band may relate to a plurality of factors about the tires on which the band is to be used. For example, if the tire on which the band is to be placed has tread wear due to use of the tires, the elasticity does not need to be as enhanced as a band that is used on a new tire.

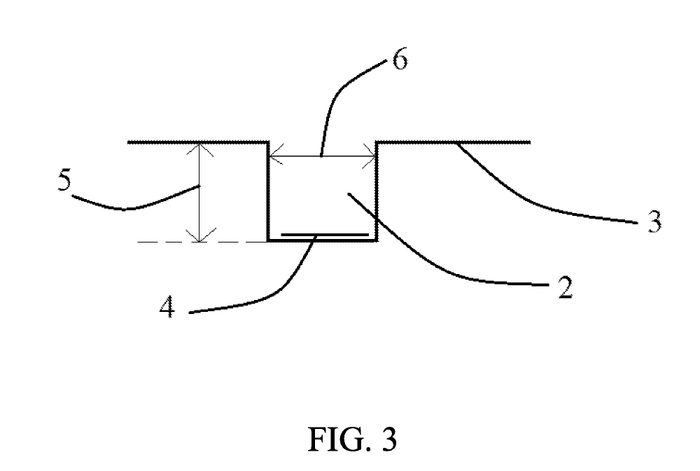

FIG. 3 shows a cross-sectional view of the outer circumference of an automobile tire. Groove 2 presents a valley in the tread 3. In this view, one should note that band 4 is present in groove 2. In this figure, band 4 is not shown to be directly adjacent to and in contact with the circumferential surface in groove 2, however, it should be understood that contact with the circumferential surface of groove 2 can happen as it is dependent on the circumference of the band 4 and the band's elasticity. That is, if the band's circumference is slightly smaller than the circumferential surface of groove 2, then the band will be in contact with the circumferential surface of groove 2. In FIG. 3, one should note that the groove 2 has a depth 5 and a width 6. As tread 3 wear happens, the circumference of the automobile tire at the tread 3 decreases and consequently, the depth 5 of the groove 2 also decreases due to disappearance of the tread. As explained above, the tire with tread wear will mean that the band 4 needs to stretch less to fit on a tire that has tread wear relative to fitting on an automobile tire that is new. This is because a tire with tread wear has a smaller circumference than a tire that has no tread wear.

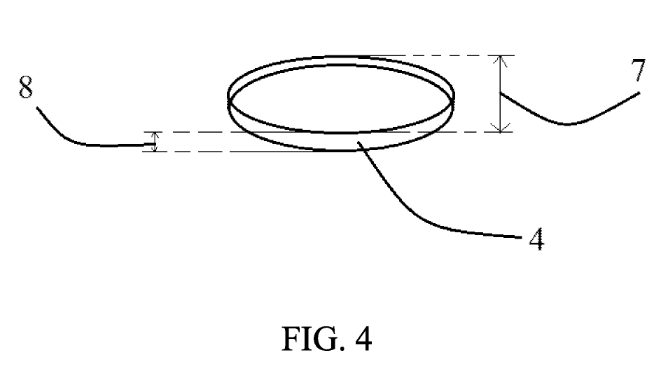

The band width 8 (see FIG. 4) of band 4 should be slightly or substantially less than the groove width 6 of groove 2 (see FIG. 3) so that it can fit in the groove 2. In an embodiment, the groove width 6 of groove 2 on an automobile tire is between about 1/16 inch to ¾ inch. Thus, the width 8 of the band 4 should be slightly less than between about 1/16 inch to ¾ inch. In an embodiment, the width 8 of band 4 is about ⅛ inch. As shown in FIG. 4, the diameter 7 of band 4 will determine the circumference (the circumference C=(diameter)(π)). Thus, the diameter 7 of the band 4 will be determined by the tire on which it is to be used.

In an embodiment, the band can be a color that is particularly visible. For example, the band may be a color that is neon in appearance. For example, the band may be neon green, neon pink, or neon orange. Alternatively, the band may be bright blue, bright red, bright yellow, bright purple, or any other bright color. Alternatively, the band color may be any color that exists (including white and/or black). In an embodiment, the band may comprise two or more colors. In a variation, the band may appear to be striped around the circumference of the band. In an embodiment, the band may comprise two neon colors in a striped manner. In an embodiment, the band may contain reflective colors (e.g., paint) that makes the bands particularly visible at night when illuminated with a light.

In an embodiment, a dye may be added to the band during the manufacturing process meaning that the band is that color throughout (and not just on the surface of the band). Alternatively and/or additionally, the band may have paint applied to it to give it one or more colors on the surface of the band. The paints may comprise reflective paint (such as exists on road signs) that make the bands particular visible when illuminated with light. In an embodiment, the paint may contain glass beads with a reflecting coat surface that not only makes the paint reflective, but also refracts the incident light in such a way that a viewer see the reflected light in an enhanced manner (i.e.. the incident light beam is refracted at an angle that when the incident beam encounters the reflecting coat, the same angle of light is achieved with the reflected beam so that a user sees the bright bands that are greatly illuminated).

In one embodiment, the elastic bands can be made by kneading rubber extracted from a rubber tree to heat the rubber and to form the extract into a “dough”. The kneader spits out the “dough” into chunks. The chunks are rolled to make dough into smaller portions. To these portions, one adds sulfur and other chemicals (such as pigments to colorize the bands or other chemicals to increase or decrease elasticity). The sulfur has the effect of strengthening the rubber and making it more elastic. After sulfur is added, the portion is rolled to make it very thin and cut into small bundles. These bundles are sent to extruder, and to the bundles one may add dyes and other chemicals to shape the bundles into long narrow hallow tubes. The injection of compressed air while extrusion occurs aids in the process of making the tubes. The tubes are then cooled in a water bath, and subsequently the tubes are slid on molds that contain talcum power so rubber does not stick to the molds, At this point, the tubes undergo vulcanization wherein they are heated in a steam oven to boost tensile strength and elasticity. After vulcanization, the vulcanized rubber tubes are pulled off of molds again using compressed air. The vulcanized tubes are rinsed in water bath to remove excess talcum powder, then the tubes are moistened. The final step is sending these tubes to a rotating blade that will cut the tubes to a correct uniform width for use as elastic bands in the grooves of an automobile tire.

In an embodiment, the band can be added to an automobile tire while the tire is not on a car axle. Alternatively, the band can be added to the tire while it is on a car axle. Either hydraulic jacks can be used to allow one to completely access all parts of the tire allowing the band to be put on the car. In a variation, the band can be added to the automobile tire while the car is on the ground by putting the band over the top and sides of the tire and then either moving backwards or forwards with the car allowing access to the portion of the tire that was but is no longer resting on the ground. Because the portion of the tire is no longer touching the ground, the band can be completely added to the groove in the tire.

It is contemplated that the elastic bands of the present invention can be added to any of the tires on an automobile. A plurality of bands can be added in the various grooves in each tire.

It is contemplated that the back tires may be more useful to have the elastic bands placed in their grooves as visibility of the grooves of the front tires is often obscured by the chassis of the automobile (other than one is turning the vehicle).

Moreover, it should be noted that as the tire tread pattern wears due to friction with roads, the tread circumference will decrease. At some point the tread may disappear completely so that the tread circumference is equal to the groove circumference (i.e., the tire is bald). When one approaches this point, it may be prudent to remove the elastic band(s) as the elastic band(s) may be in contact with the ground. The elastic band(s), however, can be re-used when new tires with grooves that are pronounced are procured.

In an embodiment, one or more grooves on an automobile tire may not contain one or more elastic bands, but rather one or more grooves may be painted themselves. That is, the bottom of the groove and/or the sides of the groove may be painted. In an embodiment, the one or more grooves may be painted by a paint spray can that has a nozzle on it that is sufficiently narrow so that it is able to paint only in the one or more grooves. In an embodiment, the nozzle may have a straw like attachment with a proximate end and a distal end wherein the proximate end is attached to the nozzle and the distal end is able to fit within the width of the groove. The paint when expelled from the paint spray can passes in a direction from the proximate end to the distal end. Moreover, the distal end has a diameter (when one looks at the cross section of the length of the straw like attachment) that is less than the width of the groove so that the distal end of the straw like attachment is able to touch the bottom of the one or more grooves, thus allowing one to paint the bottom of the groove without paint spillage or splatter that touches other parts of the tire (e.g., the tread portion). Accordingly, rather than having an elastic band that provides color and an aesthetic look to the tire, one applies paint directly onto the tire at the groove bottom.

In an embodiment, the present invention relates to a kit that comprises one or more bands. These one or more bands may comprise a plurality of colors. There may also be bands that are of different sizes allowing the bands to be placed on any of a plurality of tires. The bands may also be made of different materials, and thus, of different elasticity allowing the car owner to choose any band that is appropriate for the situation of the car owner. The kit may comprise paints that allow the car owner to personalize the bands that the car owner places on the tires. The kit may also comprise paint brushes that allow one to paint the elastic bands with the included paint. The kit may further comprise instructions about how to apply the band(s), how to paint the band(s) or other relevant instructions. The instructions may also contain a warning that the band should not be used if the depth of the groove is not sufficient to accommodate the band in the groove (e.g., the tire tread has worn substantially). Alternatively and/or additionally, in an embodiment, the kit may contain bands that have already been painted (with reflective or non-reflective paint). The kit may also comprise a paint spray can with an optional straw like attachment that allows one to paint in the grooves of the tire.

There may exist a plurality of different kits that the car owner can order for the particular automobile tire that exists on the owner's car. As enumerated above, the bands are designed to fit in the groove of the particular owner's tire. For example, a tire that is a P215/65R15 is a tire that has a width of the tire (from sidewall to sidewall) of 215 mm, a 65% height (from inner circumference of the tire to the outer circumference) to width ratio. This means that the distance from the inner circumference of the tire to the outer circumference of the tire is 139.75 mm, and a 15 inch diameter (i.e., twice the distance from the axle to the inner circumference of the tire). If the car owner knows the size of the tires on his/her vehicle, the proper band(s) kit can be procured by the car owner. In an embodiment, the circumference of a band designed to fit on an automobile tire is greater than about 20 inches. In an embodiment, the circumference of a band designed to fit on an automobile tire is greater than about 30 inches. In an embodiment, the circumference of a band designed to fit on an automobile tire is between about 20 and 70 inches. In an embodiment, the circumference of a band designed to fit on an automobile tire is between about 30 and 60 inches. In an embodiment, the circumference of a band designed to fit on an automobile tire is between about 30 and 50 inches. In an embodiment, the circumference of a band designed to fit on an automobile tire is between about 35 and 50 inches. In an embodiment, the circumference of a band designed to fit on an automobile tire is between about 35 and 45 inches. In an embodiment, the circumference of a band designed to fit on an automobile tire is between about 45 and 45 inches.

The present invention relates to a modified automobile tire that comprises an automobile tire that has one or more grooves, said one or more grooves having a circumference on the automobile tire in a direction parallel to an automobile when the automobile is driven, said automobile tire comprising one or more elastic bands disposed in the one or more grooves.

In an embodiment, the one or more elastic bands are made of natural rubber, synthetic rubber or a mix of natural and synthetic rubber.

In an embodiment, the circumference of one or more bands is less than a circumference of the automobile tire in the one or more grooves.

In an embodiment, the one or more elastic bands are neon colored. In an embodiment, the one or more elastic bands may be painted with paint. In an embodiment, the one or more elastic bands may be painted with reflective paint. In an embodiment, the paint may further comprises reflective glass beads.

In an embodiment, the one or more elastic bands is of a size wherein the circumference of the one or more elastic bands is between about 30 and 60 inches, or alternatively, between about 35 and 50 inches. In an embodiment, the width of the one or more elastic bands is at least about 1/16 inch or greater. In an embodiment, the width of the one or more elastic bands is between about 1/16 inch to ¾ inch.

In an embodiment, the present invention relates to a kit comprising one or more elastic bands, said elastic bands being of a size a wherein a circumference of the one or more elastic bands is between about 30 and 60 inches or larger, said kit also comprising paint to paint the elastic bands. The kit may also comprise a paint spray can with an optional straw like attachment that allows one to paint in the grooves.

In an embodiment, the kit may comprise a plurality of elastic bands. In an embodiment, the plurality of elastic bands may be of different circumferences. That is, there may be several elastic bands that are of one size and several that are of a different size. Alternatively, every band may be of a slightly different size with the circumferences and the widths of each varying in size.

In an embodiment, the kit may also comprise one or more of paint brushes and instructions.

In an embodiment, the kit may contain a plurality of elastic bands that may be neon colored. In an embodiment, the width of the one or more elastic bands is between about 1/16 inch to ¾ inch.

In an embodiment, the kit may contain a paint that comprises reflective glass beads.

In an embodiment, the present invention relates to a method of placing an elastic band on a circumferential groove of an automobile tire that is on an automobile wherein a portion of said automobile tire is touching ground, said method comprising stretching said elastic band and disposing said elastic band around a portion of the automobile tire that is not touching the ground, moving said automobile either forwards or backwards so that said portion that was touching ground is no longer touching ground and disposing said elastic band around the automobile tire. In one variation of the method, the automobile is moved forwards. In another variation, the automobile is moved backwards.

In a variation of the method, the elastic band may be colored, it may have a circumference that is between about 30 and 60 inches, and a the elastic band may have a width that is between about 1/16 inch to ¾ inch.

It is to be understood that the above is merely a description of the preferred embodiment and that various modifications could be made by one skilled in the art without departing from the concept of the invention disclosed herein. Moreover, it should be understood that it is contemplated and therefore within the scope of the invention that any feature that is described above can be combined with any other feature even if they are not mentioned together. When ranges are discussed, any number that may not be explicitly disclosed but fits within the range is contemplated as an endpoint for a sub-range within this range. The scope of protection to be afforded is to be determined by the claims which follow and the breadth of interpretation which the law allows.

We claim:

1. A modified automobile tire that comprises an automobile tire that has one or more grooves, said one or more grooves having a circumference on the automobile tire in a direction parallel to an automobile when the automobile is driven, said automobile tire comprising one or more elastic bands disposed in the one or more grooves.

2. The modified automobile tire of claim 1, wherein the one or more elastic bands are made of natural rubber, synthetic rubber or a mix of natural and synthetic rubber.

3. The modified automobile tire of claim 1, wherein a circumference of one or more bands is less than a circumference of the automobile tire in the one or more grooves.

4. The modified automobile tire of claim 1, wherein the one or more elastic bands are neon colored.

5. The modified automobile tire of claim 1, wherein the one or more elastic bands are painted with paint.

6. The modified automobile tire of claim 5, wherein the one or more elastic bands are painted with reflective paint.

7. The modified automobile tire of claim 5, wherein the paint further comprises reflective glass beads.

8. The modified automobile tire of claim 5, wherein the one or more elastic bands is of a size wherein a circumference of the one or more elastic bands is between about 30 and 60 inches.

9. The modified automobile tire of claim 8, wherein the one or more elastic bands is of a size wherein a circumference of the one or more elastic bands is between about 35 and 50 inches.

10. The modified automobile tire of claim 8, wherein the one or more elastic bands is of a size wherein a width of the one or more elastic bands is between about 1/16 inch to ¾ inch.

11. A kit comprising one or more elastic bands, said elastic bands being of a size a wherein a circumference of the one or more elastic bands is between about 30 and 60 inches, said kit also comprising paint to paint the elastic bands.

12. The kit of claim 11, wherein the kit comprises a plurality of elastic bands.

13. The kit of claim 11, wherein the kit also comprises one or more of paint brushes and instructions.

14. The kit of claim 12, wherein the plurality of elastic bands are of different circumferences.

15. The kit of claim 12, wherein at least some of the plurality of elastic bands are neon colored.

16. The kit of claim 11, wherein a width of the one or more elastic bands is between about 1/16 inch to ¾ inch.

17. The kit of claim 11, wherein the paint further comprises reflective glass beads.

18. A method of placing an elastic band on a circumferential groove of an automobile tire that is on an automobile wherein a portion of said automobile tire is touching ground, said method comprising stretching said elastic band and disposing said elastic band around a portion of the automobile tire that is not touching the ground, moving said automobile either forwards or backwards so that said portion that was touching ground is no longer touching ground and disposing said elastic band around the automobile tire.

19. The method of claim 18, wherein the automobile is moved forwards.

20. The method of claim 18, wherein the elastic band is colored, a circumference of said elastic band is between about 30 and 60 inches, and a width of said elastic band is between about 1/16 inch to ¾ inch.
